(19) United States
(12) Patent Application Publication
(10) Pub. No.: US 2018/0179111 A1
(43) Pub. Date: Jun. 28, 2018

(54) BLENDED CEMENTITIOUS MIXTURES

(71) Applicants: Ping FANG, Toronto (CA); HOOTON Douglas, Toronto (CA)

(72) Inventors: Ping FANG, Toronto (CA); HOOTON Douglas, Toronto (CA)

(21) Appl. No.: 15/543,515

(22) PCT Filed: Jan. 13, 2016
(86) PCT No.: PCT/CA2016/000009

§ 371 Date: Jul. 13, 2017

Related U.S. Application Data
(60) Provisional application No. 62/102,658, filed on Jan. 13, 2015.

(51) Int. Cl. C04B 28/08; C04B 14/28; C04B 14/06

(52) U.S. Cl. CPC C04B 28/08; C04B 2111/00637; C04B 14/06; C04B 14/28

(57) ABSTRACT

A blended cementitious mixture is disclosed, the blended cementitious mixture comprising: a cement included in an amount corresponding to greater than 3% and less than 40% by mass of powders in the cementitious mixture; supplemental cementitious materials included in an amount corresponding to greater than 50% and less than 90% by mass of powders in the cementitious mixture and a carbonate source included in an amount less than or equal to 20% by mass of powders in the cementitious mixture. The cementitious mixture can be mixed with concrete sand, water, chemical admixtures and coarse aggregates and cured to form concrete.

This application claims priority from and the benefit of the filing date of U.S. Provisional Patent Application No. 62/102,658, filed Jan. 13, 2015, and the entire content of such application is incorporated herein by reference.

### TECHNICAL FIELD

The present matter generally relates to cements and, more specifically, to blended cementitious mixtures with low cement content.

### BACKGROUND

Human-related carbon dioxide (CO₂) gas emissions are increasing average global surface temperatures which are having both recognized and unknown effects on the environment. The reduction of CO₂ emissions is of global concern. Besides processed water, concrete is the largest-volume manufactured product on earth. The global average CO₂ emission per tonne of cement manufactured is estimated to be about 0.8-1 tonnes. Almost all cement is used to make concrete. Globally, it is recognized that alternative cement and concrete technologies are required for earth's sustainability.

Portland cement (PC) is the most commonly used construction cement today. Portland cement is a mixture comprising primarily calcium silicate and calcium aluminate minerals which react with water to form a dense paste used as a concrete binder. CO₂ is a by-product of the conversion process in the production of clinker and an intermediate component of cement, in which limestone (CaCO₃) is converted to lime (CaO). CO₂ is also emitted during cement production by fossil fuel combustion required to heat the limestone and other components to approximately 1450° C. In addition to its related CO₂ emissions, due to its high heat of hydration, Portland cement is unsuitable for use in some environments. For example, its high heat of hydration can cause cracking or buckling when ordinary or pure Portland cement is used in mass concrete. Moreover, due to its rather high permeability, durability of concrete is reduced in climates where freezing and thawing occur frequently. In anticipation of more controlled CO₂ industrial regulations which aim to protect earth's atmosphere, concrete mixtures with lower Portland cement content that do not drastically increase production costs have been the subject of research and development.

In recent years, one of the primary approaches to producing more sustainable concretes (e.g. concretes that emit or produce decreased levels of CO₂ during production when compared to the production of standard concretes) consists of replacing 50% or more (e.g. 60%) of the Portland cement content found in conventional concrete mixtures with supplementary cementitious materials (SCMs), such as grounded blast-furnace slag (e.g. slag) and fly ash (FA). However, these low Portland cement content mixtures containing high volume SCMs (HVSCMs) suffer from: unacceptable delays in setting times, insufficient early-age strength and increased sensitivity to curing conditions.

Fine limestone powders (e.g. median particle size smaller than 6 μm) have been employed to improve the early-age strength of HVSCMs concrete. Concrete manufactured by replacing 60% in volume of Portland cement with 45% fly ash and 15% fine limestone powders has been reported. This concrete had a similar setting time compared to reference Portland cement concrete and improved transport properties in rapid chloride permeability testing (RCPT).

There are many mechanisms to increase the early-age strength of HVSCMs. For example, a chemical reaction between metakaolin and limestone powders has been employed to enhance the early-age strength of HVSCMs. In another example, a sustainable binder (specifically Limestone Calcined Clay Clinker Cement (LC3)) has been developed where 45% of Portland cement content was substituted with 30% metakaolin and 15% limestone powders. Concrete formed from this modified Portland cement showed better mechanical properties at the 7^{th} and the 28^{th} days of curing than concrete formed from 100% Portland cement. This increased strength resulted from a reaction between calcium carbonate from the limestone powders and alumina from the metakaolin that produced supplementary alumina, ferric oxide, monosulfate (AFm) phases and stabilizing ettringite.

Another sustainable cementitious material was developed by using the reaction between alumina from aluminous sources and calcium carbonate from carbonate sources. As described in US2015/0210592 by Sant et al, this concrete consists of Portland cement (30%-80% by mass of the cementitious materials), a carbonate source (more than 20% by mass of the cementitious materials), and an aluminous source.

Optimized particle sizes distributions and addition of alkali salts, e.g, Na₂SO₄, or mixtures thereof can also be employed to improve the early-age strength of low Portland cement contents concrete.

Alkali-activated concrete (e.g. geopolymer concrete) is a kind of sustainable binder without Portland cement. Its main constituent is SCMs (e.g. slag, fly ash and metakaolin, or mixture thereof) which is activated by alkali solutions to provide binder characteristics. Its primary binder phases are C-(A)-S-H gel and N-A-S-(H) gel. There are also some hydrotalcite-like and/or zeolites crystalline phases. This kind of binder is more expansive than Portland cement and its durability is under improvement. Unfortunately, alkali-activated concrete it does not have good coherence with chemical admixtures which are widely used in Portland cement concrete.

Supersulfated cement is another kind of sustainable binder comprising less Portland cement than conventional concrete. The main constituent of supersulfated cement is slag (80-85%) which can be activated by Portland cement (about 5%) and calcium sulfate (10-20%). Its initial setting time is often longer than that of Portland cement and its early-age strength development is also slower than Portland cement. However, the 28^{th} day strength of supersulfated cement is similar to that of Portland cement. Supersulfated cement is easily carbonated to increase porosity. Its main hydration products are ettringite and C-S-H. AFm and hydrotalcite are also found existing in its hydration products.

As a kind of supplemental material for part of Portland cement, reactive magnesium oxide is also under research in many laboratories. It has been reported that 90% by mass of Portland cement could be replaced by a combination of reactive magnesium oxide and fly ash. This type of blended cement has slow development of the compressive strength when it is cured in 23° C. water for 28 days. However, it shows good development of strength when it is cured in a high concentration atmosphere of CO₂.

There is a need in the art for a cementitious material that can be used for preparation of concrete having desirable properties, while also helping to mitigate some of the challenges noted above.

### SUMMARY OF THE INVENTION

It is an object of the present invention to provide a blended cementitious mixture with low cement content. The blended cementitious mixture can be formed into a mortar or a concrete with similar early-age strength and durability (as described below) to conventional concretes as achieved by synergistic workings of the constituents. These advantages have not heretofore been achieved in the art.

According to one embodiment, a blended cementitious mixture with low cement content and similar compressive strength when formed into concrete as Portland cement concrete is disclosed, the blended cementitious mixtures comprising: a cement included in an amount corresponding to greater than 3% and less than 40% by mass of powders in the cementitious mixture; supplemental cementitious materials included in an amount corresponding to greater than 50% and less than 90% by mass of powders in the cementitious mixture, and a carbonate source in an amount less than 20% by mass of powders in the cementitious mixture.

According to another embodiment, a blended cementitious mixtures is disclosed wherein the proportions of the constituents of the blended cementitious mixture are designed to work synergistically to enhance the early-age strength of the mixtures formed therefrom.

According to yet an embodiment, a concrete is disclosed, wherein the concrete is formed by mixing a blended cementitious mixture disclosed herein with sand, water and chemical admixtures and curing the mixture to form a concrete. The concrete has a higher 28 day compressive strength, stable dimensions and excellent durability when compared to conventional Portland cement concrete.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

FIG. 1 is a cumulative distribution analysis graph showing particle size distributions of the constituents of blended cementitious materials;

FIGS. 2(a) to 2(e) are line graphs showing pore size distributions of conventional Portland cement and four different BCMs with varying Portland cement content;

FIG. 3 is a line graph showing pore size distributions of SUHPC; and

FIG. 4 is a bar graph showing the effects of various curing regimes on compressive strength of SUHPC.

### DETAILED DESCRIPTION

The blended cementitious mixtures (BCMs) disclosed herein provide a low Portland cement content binder which, when formed into concrete, has advantageous properties (e.g. compressive strength, durability, etc.) when compared to conventional concretes such as but not limited to Portland cement concrete and alkali-activated cement concrete.

The BCM described herein are blends of conventional cementitious materials. In one embodiment, a conventional cement (e.g. Portland cement) is included in an amount corresponding to greater than 3% and less than 40% by mass of the BCM, the supplementary cementitious materials (SCMs) (e.g. fly ash, ground granulated blast-furnace slag, pozzolan, metakaolin and silica fume) are included in an amount corresponding to greater than 50% and less than or equal to 90% by mass of the BCM, and the carbonate source is included in an amount less than or equal to 20% by mass of the BCM. In another embodiment, the carbonate source is a fine carbonate source whereby the carbonate source has a median particle diameter of no more than 17 μm and preferably less than or equal to 12 μm.

In another embodiment, approximately half (e.g. 50%) of the SCMs can be replaced by limestone powders with a median particle diameter in the range of 12 μm-100 μm and preferably within the range of 12 μm-17 μm.

It should be noted that the procedure for the blending the BCM can be any procedure used to blend conventional Portland cement including any existing industrial installation or in the field of concrete mixing.

Herein, Portland cement can refer to any conventional Portland cement including but not limited to normal Portland cement (ASTM C150 Type I), high early strength Portland cement (ASTM C150 Type III) and Portland-limestone cement (ASTM C595 Type IL). Further, use of a cement in the BCM described herein can include use of a calcium aluminate cement.

SCMs generally include but are not limited to fly ash, ground granulated blast-furnace slag, pozzolan, metakaolin, silica fume or any other commercial product that can be used in Portland cement concrete.

A carbonate source for the BCM described herein can include but is not limited to one of limestone powders, dolomite powders, vaterite powders, aragonite powders, cement kiln dusts or a mixture thereof.

Herein, the term BCM mortars refer to mixtures of BCM with sand and water and optionally chemical admixtures, wherein chemical admixtures are ingredients in concrete other than Portland cement, water, and sand that are added to the mix immediately before or during mixing. Chemical admixtures can include but are not limited to water-reducing admixtures, retarding admixtures, accelerating admixtures, superplasticizers and/or corrosion-inhibiting admixtures.

Further, herein BCM concretes refers to mixtures of BCM mortars (with or without chemical admixtures) with coarse aggregates, wherein coarse aggregates generally refers to but is not limited to aggregate ranging between ⅜ and 1½ inches in diameter. Gravels and other crushed stone are two examples of coarse aggregate. Further, herein, fine aggregates generally refers to natural sand or crushed stone with most particles passing through a ⅜-inch sieve.

The methods of mixing, casting and curing of BCM mortars and concrete described herein can be the same as those of conventional Portland cement mortars and concrete.

Although the constituents of the BCM disclosed here and the procedures of mixing, casting and curing BCM mortars and concrete disclosed herein can be the same as those of conventional Portland cement, mortars and concrete, respectively, the properties of the BCM disclosed herein are mainly due to the proportions of the constituents (e.g. PC, SCMs and carbonate source) of the BCM. These proportions can provide advantageous chemical compositions of elements in the mixture (e.g. calcium aluminosilicate system) with some carbonate ions affecting the mineralogical variant of the reaction products, while keeping the Portland cement contents as low as possible.

The sustainable BCM described herein were also designed on the basis of Reactive Powder Concrete (RPC) and Ultra-High Performance Concrete (UHPC) which combine optimization of particle size distributions to produce a cement concrete with increased compressive strength and lower CO₂ emissions when compared with conventional concretes (e.g. concrete made from Portland cement). It should be noted that the term sustainable used herein refers to lower CO₂ emissions. Therefore, sustainable blended cementitious materials offer lower CO₂ emissions upon production into concrete when compared with conventional cements and concretes formed therefrom. In one embodiment, the blended cementitious mixture is capable of meeting the requirements of ASTM C-595.

The development of sustainable BCM for use in concrete disclosed herein focused on reducing the amount of cement (e.g. Portland cement, calcium aluminate cement) in the mixture by: i) including industrial by-products such as but not limited to fly ash and slag in the mixture; ii) utilizing low energy and low cost materials (e.g. readily available materials) as raw materials in the mixture (e.g. limestone powders); and iii) producing a concrete with high durability.

In the following examples, the term Sustainable Ultra High Performance Concrete (SUHPC) refers to a mixture of BCM and fine aggregates (e.g., quartz powders, limestone powders, sand, or the mixtures thereof), concrete chemical admixtures and water. The SUHPC disclosed herein generally has a compressive strength higher than 80 MPa at the age of 28 days and also has excellent durability (e.g. less shrinkage and corrosion than conventional concretes when experiencing similar exposures).

The effects of varying the content of Portland cement in the BCM disclosed herein on the compressive strength of SUHPC made therefrom were analyzed. In one example embodiment, the effect of decreasing Portland cement contents from 600 kg/m³ (60% by mass of the powders) to 350 kg/m³ (35% by mass of the powders) was analyzed. The compressive strength of the resulting cured SUHPC increased from 128.3 MPa to 130.6 MPa after the SUHPC samples cured in 85° C. hot water for three days (see Table 1). When the same SUHPC mixture samples were cured in 23° C. limewater for 28 days, the compressive strengths increased from 88.3 MPa to 102.9 MPa as Portland cement content was decreased from 600 kg/m³ (60% by mass of the powders) to 350 kg/m³ (35% by mass of the powders). This was quite different from the conventional Portland cement concrete.

TABLE 1
Effects on Portland Cement Contents
on Compressive Strength of SUHPC

| | | | | | | Compressive | | |
|---|---|---|---|---|---|---|---|---|
| | | | | | | strength (MPa) | | |
| (kg/m³) | | | | | | 23° C. | | 3 d 85° C. |
| | | | Sand | | | Water Curing | | Water |
| PC | SL | SF | 315 μm | W/P | SP | 3 d | 28 d | Curing |
| 600 | 300 | 100 | 1124 | 0.20 | 90 | 84.8 | 88.3 | 128.3 |
| 350 | 450 | 200 | 1124 | 0.20 | 90 | 64.9 | 102.9 | 130.6 |

Note:
PC—Portland cement;
SL—slag;
SF—silica fume;
W/P—water/(PC + SL + SF);
SP - Polycarboxylate High Range Water Reducer Admixture

In one example, an increase in early-age strength (e.g. less than 7 days) was also measured for a SUHPC mixture with Portland cement content 350 kg/m³ (35% by mass of the powders) (see Tables 2 and 3). The compressive strength rose sharply from the 1^{st} day at 15.3 MPa to the 2^{nd} day 44.5 MPa, which was much faster than that of conventional Portland cement concrete. This SUHPC mixture had the compressive strength of 96.4 MPa after cured in limewater for 28 days (see Table 3).

TABLE 2
Mixture Proportions of SUHPC (kg/m³)

| | | | | | Sand | | |
|---|---|---|---|---|---|---|---|
| PC | SL | LM-12PT | SF | LM-3PT | 600 μm | W/P | SP |
| 350 | 225 | 225 | 50 | 150 | 1124 | 0.22 | 40 |

TABLE 3
Development of Compressive Strength of SUHPC

| | Age | | | | | | | |
|---|---|---|---|---|---|---|---|---|
| | 1 | 2 | 3 | 4 | 5 | 6 | 7 | 28 |
| Compressive | 15.3 | 44.5 | 53.2 | 58.5 | 68.1 | 69.5 | 72 | 96.4 |
| Strength (MPa) | | | | | | | | |

### Characteristics of BCM Products

Herein, the term BCM products refers to BCM, BCM mortars, SUHPC and BCM concretes.

The BCM products had similar setting time when compared to conventional Portland cement concrete and, as shown in the examples provided below, the BCM products have sharply increased compressive strengths between the 1^{st} and the 3^{rd} day and between the 3^{rd} and the 7^{th} day of curing, as well as steadily increasing compressive strengths after the 7^{th} day.

The BCM products can be cured in 23° C. limewater, in no higher than 95° C. hot limewater, or in steam under 1 atm or higher than 1 atm. Following this, the BCM products can continue to have improved compressive strength by curing in air after being cured in 23° C. limewater for no less than 7 days or after curing in elevated temperature with humidity/limewater or in a humidity CO₂ environment.

Carbonation is good for BCM products, both in the development of strength and in the enhancement of durability. Further, the BCM concrete has high splitting tensile strength.

The BCM products have stable dimensions. The chemical shrinkage of the BCM is smaller than that of Portland cement. The drying shrinkage of the SUHPC increases slightly after 7 days of curing.

The BCM products are coherent with concrete chemical admixtures and produce low hydration heat when compared with conventional Portland cement concrete.

More than 80% of the pore size distributions of the BCM products are in the range of nano-pore sizes (<10 nm) which are quite different from conventional Portland cement concrete.

The volume of permeable pore sizes of BCM products is much lower than that of conventional Portland cement.

The excellent durability is the outstanding feature of the BCM products. They have advantaged durability over conventional Portland cement concrete in the resistance to chloride ions diffusion, to sulfate attack, to sea water attack, to alkali-aggregate reactivity, to corrosion of steel, to freezing/thawing and deicer damage.

There are two main reactions in BCM. The first reaction is the pozzolan reaction between the calcium hydroxide from the hydration products of Portland cement and the reactive siliceous or aluminosiliceous materials from SCMs in the presence of moisture or water. The productions of this pozzolan reaction are calcium silicate hydrate and other cementing compounds.

The other kind of reaction is the aluminate phases present in Portland cement and in SCMs (e.g. metakaolin, slag, fly ash and pozzolan) reacting with fine limestone powders in the presence of moisture or water and excess calcium ions.

The reactivity of each of the SCMs is different. For example, silica fume shows the most reactivity in the pozzolan reaction and metakaolin is the best SCM to react with limestone powders. Slag shows more reactivity than fly ash in both the pozzolan reaction and the second reaction with limestone powders provided above.

As Portland cement contents decreasing, the pozzolan reaction will become weaker. Therefore, more active SCMs are needed to provide BCM products with increased early-age strength.

In this disclosure, the constituents were designed to work synergistically to provide improved early-age strength for the BCM as described in the following examples.

Specifically, one of SCMs is considered to be a predominate SCM, for example fly ash as it is commonly available in most areas of the United States. Then, metakaolin, or slag or silica fume, or a mixture thereof, is employed as a subordinate SCM to react with Portland cement and limestone powders to make up for the low reactivity of fly ash.

The embodiments of the present disclosure described herein are intended to be examples only. Some alterations, modifications and variations to the described embodiments may be made without departing from the intended scope of the present disclosure. The described embodiments may be combined in many instances unless otherwise stated or unless incompatible with the teachings of the present disclosure. In addition, one or more features of the described embodiments may be used in isolation as a sub-combination or may be combined with other embodiments or sub-combinations in alternate embodiments not explicitly described herein but consistent with the teachings of the present disclosure. Features suitable for such combinations and sub-combinations would be readily apparent to persons skilled in the art upon review of the present disclosure as a whole.

These and other advantages and features of the present disclosure will become more fully apparent from the following description of example embodiments and the appended claims, or may be learned by the practice of the present disclosure as set forth in the figures and examples provided.

### Experimental Methodologies and Examples

### Constituent Materials

The following is a list of materials that were used to achieve the following results in the development of BCM products:
Portland cement (PC), ASTM C150, Type I
Ground Granulated Blast-Furnace Slag (SL), ASTM C 989
Fly Ash—F Class (FA), ASTM C 618
Silica Fume (SF), ASTM C1240
Metakaolin (MK), ASTM C 618
Limestone Powder (LM), ASTM C 568
Quartz Powders (QZP)
Graded Standard Sand (SS), ASTM C778
Concrete Sand, ASTM C33
Polycarboxylate High Range Water Reducer Admixture (SP), ASTM C494
Tap Water (W)

### Properties of Constituent Materials

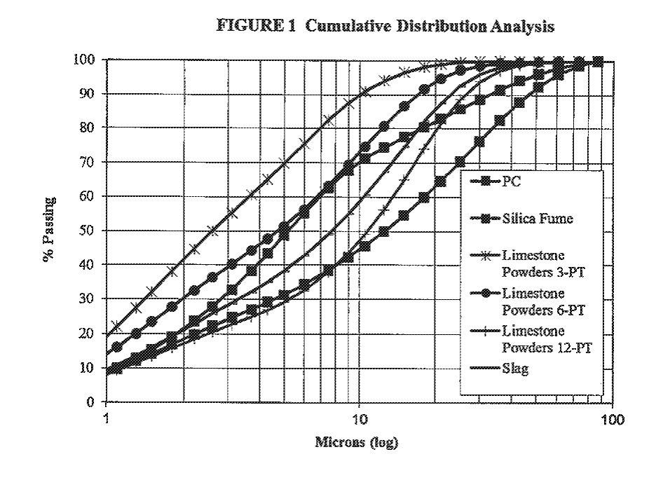

The chemical compositions of the constituent materials are shown in Table 4. The limestone powders 3-PT, 6-PT and 12-PT have the Specific Surface Areas (SSA) at 1.135 m²/g, 0.720 m²/g and 0.380 m²/g, respectively. Their particle size distributions are plotted in FIG. 1.

TABLE 4
Chemical Compositions of Constituents Materials

| | SiO₂ | Al₂O₃ | Fe₂O₃ | CaO | MgO | K₂O | Na₂O | SO₃ | LOI |
|---|---|---|---|---|---|---|---|---|---|
| PC | 19.78 | 5.43 | 2.16 | 61.59 | 2.36 | 1.23 | 0.250 | 4.06 | 2.26 |
| SL | 37.41 | 9.01 | 1.21 | 35.75 | 12.42 | 0.37 | 0.31 | 2.89 | 0 |
| FA | 54.17 | 24.10 | 3.85 | 11.07 | 1.14 | 0.67 | 2.86 | 0.23 | 0.58 |
| MK | 62.30 | 30.50 | 1.10 | 0.43 | 0.30 | 1.79 | 0.16 | 0.08 | 2.87 |
| SF | 94.48 | 0.24 | 0.63 | 0.44 | 0.38 | 1.01- | 0.16 | 0.36 | 2.53 |
| LM 3-PT | — | — | — | 96.00 | 2.00 | — | — | — | — |

### Mixing, Casting and Curing

The specimens of mortar and concrete were mixed, casted and cured according to ASTM C 109 and ASTM C39 before the 28^{th} day, respectively. After the 28^{th} day, they were cured in the lab at approximately 23° C. and approximately 50% R.H.

The pastes for the research of Mercury Intrusion Porosimetry (MIP) had the same constituents and the same mixture proportions as their mortars except of no sand. They also had the same curing regimes as those of their mortars.

The hydration of the pastes were stopped by crushing the samples to 1-3 mm, then immersing them in 2-propanol solution for at least 3 days, followed by a vacuum drying at 38° C. for at least 3 days.

### Property Measurement Methodologies

The properties of BCM and SUHPC were measured according to ASTM Standards provided in Table 5.

The measurement method of the swelling was the same as that of the drying shrinkage (ASTM C157) except the curing regime varied. The swelling specimens were immersed in the limewater at 23 ±2° C. after demoulded until the test ages. After the measurement of the length, the specimens were put back into the water immediately.

The MIP measurements were conducted on Quantachrome Autoscan Porosimeter. The data were obtained up to a maximum pressure of 400 MPa.

TABLE 5
Properties measured and associated measurement standards

| | | ASTM |
|---|---|---|
| Materials | Properties | Standards |
| Mortar | Compressive strength | C109-13 |
| Concrete | Porosity | |
| | Bulk porosity | C642-13 |
| | Air void analysis | C457-12 |
| | Mercury Intrusion Porosimetry (MIP) | / |
| | Mechanical properties | |
| | Compressive strength | C39-10 |
| | Static modulus of elasticity | C469-14 |
| | Dynamic modulus of elasticity | C215-08 |
| | Splitting tensile strength | C496-04 |
| | Early age cracking properties | |
| | heat of hydration | C1679-13 |
| | length change of drying | C157-08, |
| | length change of swelling | |
| | Durability | |
| | sulfate attack | C1012-13 |
| | chloride diffusion, | C1202-10 |
| | bulk electrical conductivity | C1760-12 |
| | potential alkali reactivity of aggregates | C1260-14 |
| | scaling under freezing and thawing | C672-12 |

### EXAMPLE EMBODIMENTS

### Embodiment 1

### Blended Cementitious Materials (BCM)

### Effects of Portland Cement Contents on Compressive Strength of BCM

In this study, the BCM consisted of slag, fly ash, limestone powders 3-PT and Portland cement. The mixture proportions were designed to research the development of the compressive strength as the Portland cement contents decreased from 100% to 5% by mass of the BCM. To make the BCM could obtain strength at very low Portland cement contents, the constituents were designed to work synergistically. As the Portland cement contents decreasing, the slag contents were increased, while the fly ash and the limestone powders were fixed at their contents (Table 6).

TABLE 6
Effects of Portland Cement Contents on Compressive Strength of BCM

| | Cementitious Materials | | | | Compressive Strength (MPa) (ASTM C109) | | | | | |
|---|---|---|---|---|---|---|---|---|---|---|
| ID | PC | SL | FA | LM | 1 d | 3 d | 7 d | 28 d | 56 d | 90 d |
| TP100 | 1.00P | 0 | 0 | 0 | 25.5 | 34.4 | 38.4 | 40.8 | 41.5 | 49.1 |
| TP50 | 0.50P | 0.23P | 0.12P | 0.15P | 8.8 | 17.5 | 30.3 | 46.5 | 47.3 | 59.5 |
| TP45 | 0.45P | 0.28P | 0.12P | 0.15P | 8.9 | 17.6 | 29.1 | 46.5 | 52.6 | 60.8 |
| TP40 | 0.40P | 0.33P | 0.12P | 0.15P | 6.3 | 13.7 | 28.8 | 49.3 | 49.6 | 63.2 |
| TP35 | 0.35P | 0.38P | 0.12P | 0.15P | 4.8 | 11.9 | 26.2 | 41.2 | 48.1 | 61.1 |
| TP30 | 0.30P | 0.43P | 0.12P | 0.15P | 3.7 | 9.2 | 23.3 | 46.9 | 49.1 | 57.0 |
| TP25 | 0.25P | 0.48P | 0.12P | 0.15P | 2.5 | 9.7 | 24.8 | 39.1 | 43.1 | 53.3 |
| TP20 | 0.20P | 0.53P | 0.12P | 0.15P | 1.9 | 5.6 | 19.3 | 40.5 | 44.8 | 53.2 |
| TP15 | 0.15P | 0.58P | 0.12P | 0.15P | 0.8 | 3.2 | 17.7 | 35.6 | 42.7 | 51.2 |
| TP10 | 0.10P | 0.63P | 0.12P | 0.15P | 0.4 | 5.7 | 18.1 | 34.8 | 36.9 | 42.3 |
| TP5 | 0.05P | 0.68P | 0.12P | 0.15P | 0 | 2.4 | 12.7 | 23.7 | 26.4 | 31.8 |

Note:
P = PC + SL + FA + LM

The compressive strength of all the BCM increased with time.

Compared with the reference Portland cement (TP100), the BCM had more development of the compressive strength after the 28^{th} day when they were cured in the room environment (at approximately 23° C. and approximately 50% R.H.). The specimens were found being partly carbonated. Longer the specimens were in the air, deeper the carbonation happened. Lower the Portland cement contents were employed, deeper the carbonation occurred. This means that carbonation is not harmful for the BCM to develop its strengths.

The BCM with the Portland cement content of 5% by mass of powders showed unexpected development of the compressive strength.

The BCM could obtain the first day compressive strength at the Portland cement content of 10% by mass of powders.

The BCM with the Portland cement content of 15% by mass of the powders had higher compressive strengths than those of the reference Portland cement after the 56^{th} day age.

The BCM with the Portland cement content of 25% by mass of powders had a compressive strength at the 28^{th} day age which was very close to that of the reference Portland cement and had higher compressive strengths than those of the reference Portland cement after the 28^{th} day age.

The BCM with the Portland cement content of 35% by mass of powders had the compressive strengths higher than those of the reference Portland cement at and after the 28^{th} day age.

### Pore Size Distributions of BCM Measured by MIP

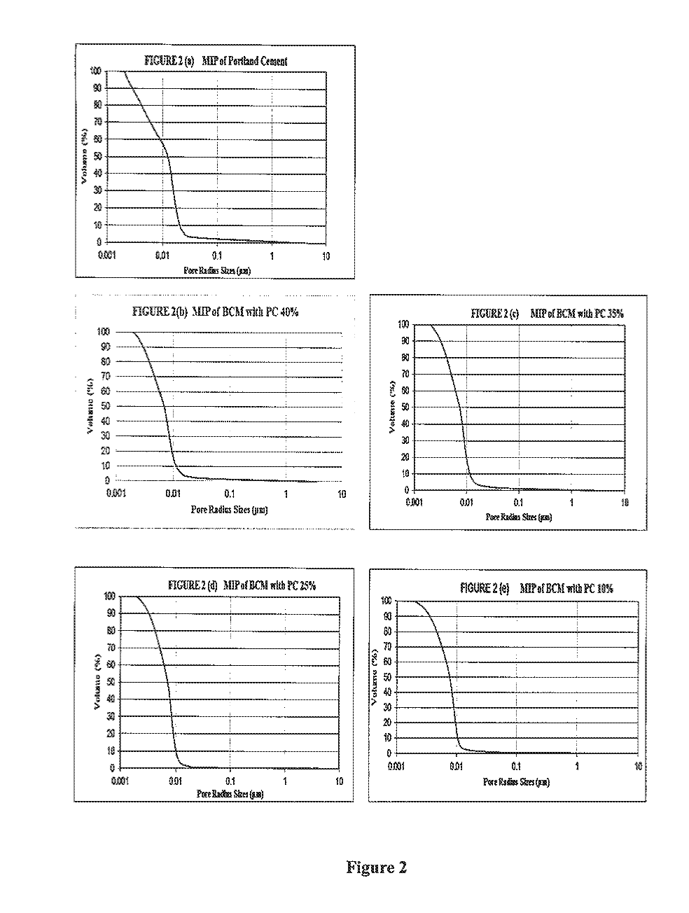

More than 80% of the pore size distributions of the BCM were in the range of smaller than 0.01 μm (FIGS. 2(b) to 2(e)). This is quite different with conventional Portland cement which had less than 55% of the pore size distributions in the range of smaller than 0.01 μm (FIG. 2(a)).

### Embodiment 2

### Synergistic Effects

### Synergistic Effects of Constituents on the Development of Early-Age Strengths

Based on the different reactivity and chemical compositions of SCMs, mixtures were designed to make the constituents of the BCM to synergistically work to improve the early-age strengths. The experiments were according to ASTM C 109. Standard sand was used and the ratio of sand to powder was 2.75. The ratio of water to powder was 0.485.

There were four kinds of SCMs presented in the mixtures shown in Table 7. In this example, fly ash was the predominate SCM and had a content of at least 80% by mass of the SCMs. Fly ash has the lowest reactivity among the SCMs presented in Table 7. The BCM with only fly ash had the lowest compressive strengths at the 1^{st} day age and the 3^{rd} day age.

Slag, metakaolin and silica fume comprised the subordinate SCM which were employed to make up the shortage of the predominate SCM, here was the fly ash, and to make all of the BCM constituents to work synergistically.

The BCM with the sole slag as the subordinate SCM at 12% by mass of the powders had lower compressive strengths than those of the BCM with the same content of the sole metakaolin as the subordinate SCM at all the early-ages.

The BCM with the sole silica fume as the subordinate SCM at 12% by mass of the powders had the compressive strength highest at the first day age but the lowest at the 7^{th} day age. This high compressive strength at the first day age may be because of the nucleation effect of the silica fume and the high reactivity of the silica fume with Portland cement. Its lowest compressive strength at the 7^{th} day age may be because the content of the calcium hydroxide from the hydration products of Portland cement decreased quickly as the fast reaction between the silica fume and the calcium hydroxide.

Either the subordinate SCM combining slag, metakaolin and silica fume, or the subordinate SCM combining metakaolin and silica fume, had the high compressive strengths at the early-ages.

TABLE 7
Synergistic Effects of Constituents on Early-Age Strengths

| | | | | | | Compressive strength | | |
|---|---|---|---|---|---|---|---|---|
| Constituents | | | | | | (MPa) | | |
| PC | FA | SL | MK | SF | LM-3PT | 1 d | 3 d | 7 d |
| 0.25P | 0.60P | 0 | 0 | 0 | 0.15P | 1.8 | 6.9 | 11.9 |
| | 0.48P | 0.12P | 0 | 0 | | 2.4 | 7.5 | 11.6 |
| | 0.48P | 0.06P | 0.03P | 0.03P | | 3.1 | 7.6 | 14.3 |
| | 0.48P | 0 | 0.06P | 0.06P | | 2.9 | 8.0 | 12.8 |
| | 0.48P | 0 | 0.12P | 0 | | 2.9 | 8.4 | 13.3 |
| | 0.48P | 0 | 0 | 0.12P | | 3.3 | 7.6 | 10.0 |

Note:
P = PC + SL + FA + LM

For the BCM with slag as the predominate SCM, fly ash and silica fume were employed as the subordinate SCM to modify the early-age compressive strengths (Table 8) when the Portland cement content was at 25% by mass of the powders.

Silica fume had the most effective impact on compressive strength. As shown in Table 8, the early-age compressive strengths of the BCM with the sole silica fume as the subordinate SCM approached to the requirement of ASTM C 595 at the Portland cement content only 25% by mass of the powders.

Both the subordinate SCM with the sole fly ash or with the combination of the fly ash and silica fume, showed obvious improvement on the early-age compressive strengths of the BCM with only the slag as the SCMs.

TABLE 8
Synergistic Effects of Constituents on Early-Age Strengths (2)

| | | | | | Compressive strength | | |
|---|---|---|---|---|---|---|---|
| Constituents | | | | | (MPa) | | |
| PC | FA | SL | SF | LM-3PT | 1 d | 3 d | 7 d |
| 0.25P | 0 | 0.60P | 0 | 0.15P | 2.1 | 8.0 | 16.8 |
| | 0 | 0.48P | 0.12P | | 2.9 | 14.1 | 27.5 |
| | 0.12P | 0.48P | 0 | | 2.5 | 9.7 | 24.8 |
| | 0.06P | 0.48P | 0.06P | | 2.4 | 10.5 | 25.5 |

| | | | |
|---|---|---|---|
| Type IT (P < S < 70), ASTM C595 | — | 13.0 | 20.0 |

### Embodiment 3

### Sustainable Ultra High Performance Concrete (SUHPC)

SUHPC with Portland Cement Content at 35% by Mass of Powders

The SUHPC was designed on the basis of the finding that the compressive strength of 102.9 MPa at the 28^{th} day could be approached with Portland cement content only at 350 kg/m³ (Table 1). There were some adjustments as following. Different particle sizes of limestone powders were used: 12-PT for replacing half of the slag, 6-PT for enhancing the early-age strengths and 100-PT for replacing part of the sand to add a particle size grade for optimization of the particle sizes packing (Table 9).

TABLE 9
Mixture Proportions of SUHPC with Portland Cement of 350 kg/m³

| BCM | | | | | Sand | | | |
|---|---|---|---|---|---|---|---|---|
| | | LM | | LM | LM | Sand | | |
| PC | SL | 12-PT | SF | 6-PT | 100-PT | 600 μm | Water | SP |
| 350 | 225 | 225 | 50 | 150 | 120 | 1080 | 220 | 50 |

As shown in Table 10, the compressive strength increased 2.6 times from the 1^{st} day to the 3^{rd} day and kept fast developing to the 7^{th} day. The compressive strengths followed the 7^{th} day grew stably with time. The development of the compressive strengths was similar to that of alkali-activated materials, but was different with that of conventional Portland cement concrete.

TABLE 10
Development of compressive strengths of SUHPC

| | Age | | | | | |
|---|---|---|---|---|---|---|
| | 1 | 3 | 7 | 28 | 56 | 91 |
| Compressive Strength (MPa) | 16.2 | 42.1 | 62.2 | 76.7 | 88.7 | 91.5 |
| Ratio of f_{c} | 1 | 2.6 | 3.8 | 4.7 | 5.5 | 5.6 |

The static modulus of elasticity Es of the SUHPC at the 28^{th} age was 38.1 GPa, while its dynamic modulus of elasticity Ed at the same age was 41.8 GPa.

The splitting tensile strength of the SUHPC at the 91^{st} day age was 6.6 MPa, higher than that of conventional Portland cement concrete.

The cumulative heat of hydration of the SUHPC was 66,250 KJ/m³, much lower than that of conventional RPC which was reported at 220,000 KJ/m³ and those of conventional Portland cement concrete which was between 80,000-120,000 KJ/m³.

The dimensional stability of the SUHPC was better than that of conventional RPC. The development of the drying shrinkage of the SUHPC increased little after the 7^{th} day and the whole drying shrinkage was at low lever. The value of the swelling was only one tenth of that of drying shrinkage, could be negligible (Table 11).

TABLE 11
Length Changes of Drying and Swelling of SUHPC

| | |
|---|---|
| Drying shrinkage (%) ASTM C157 | Swelling (%) |

Age (d)

| 7 | 14 | 28 | 56 | 112 | 7 | 14 | 28 | 56 | 112 |
|---|---|---|---|---|---|---|---|---|---|
| −0.031 | −0.041 | −0.044 | −0.047 | −0.049 | −0.005 | −0.008 | −0.009 | −0.005 | −0.014 |

The SUHPC had excellent chloride diffusion resistance. Its chloride diffusion was negligible (Table 12) according to the experiments based on ASTM C1202. The average Merlin Bulk Resistivity was 1457.6 (Ω.m) which was much higher than that of conventional Portland concrete.

TABLE 12
Average RCPT Actual Charge Passed of SUHPC

| | Average RCPT Actual Charge Passed at |
|---|---|
| Materials | 28^{th} day [C] ASTM C 1202 |
| SUHPC | 84 |

### Resistance to Deicing-Salt Scaling

The salt scaling resistance of the SUHPC was very slight scaling according to the method of visual rating of the surface.

### Sulfate Resistance

The SUHPC showed excellent sulfate resistance property. The length change at the 90^{th} day age was only 0.01% and the appearance of the samples which had been immersing in the sulfate solution (ASTM C1012) for 90 days were excellent (e.g. no degradation visible).

### Bulk Porosity

The volume of permeable pore size of the SUHPC was 2.247 according to the experiment result based on ASTM C642.

### Air Voids

Measured according to ASTM C457, the air void of the SUHPC was 2.99%.

### Resistance of Alkali-Aggregate Reaction

The expansion of the SUHPC was 0.003% according to the experimental results based on ASTM C 1260. This means that the SUHPC was indicative of innocuous behavior in most cases.

### Mercury Intrusion Porosimetry (MIP)

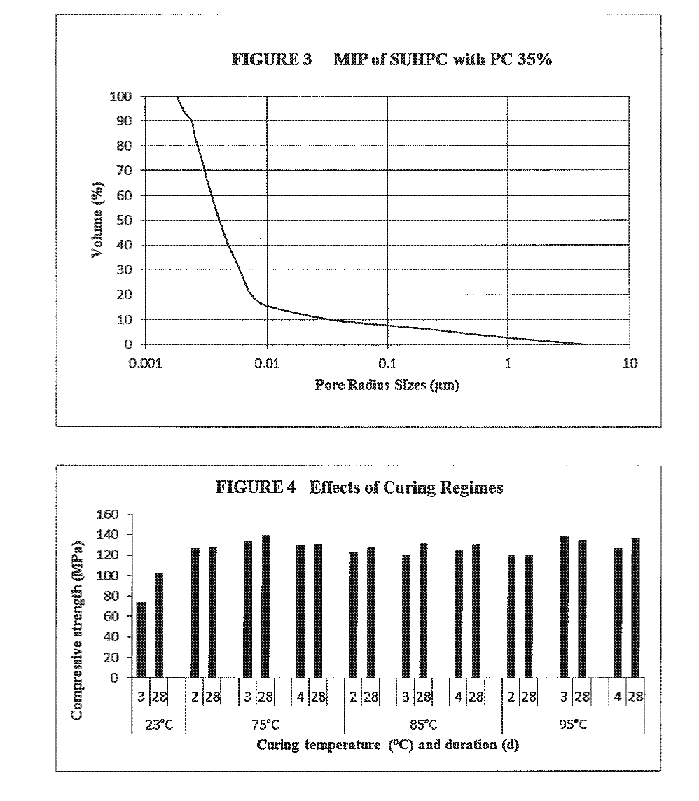

The pore sizes distributions of the SUHPC (FIG. 3) showed more than 80% of the pores were smaller than 0.01 μm which is in the range of the gel pores according to the classification of pore sizes. This means that the flow of liquid or diffusion of ions in the SUHPC would be restricted because of this feature of the pore sizes distributions which is quite different from conventional Portland cement concrete.

### Effects of Curing Regimes

The SUHPC mixture in Table 13 was cured in limewater under four different temperatures (23° C., 75° C., 85° C. and 95° C.) for three different time periods: 2d, 3d, and 4d. After cured in a high temperature lime-saturated water, one set of the samples was tested for the compressive strength immediately, while the other set of the samples was continuously cured in the room (23° C., about 50% R.H) until the 28^{th} day to be tested.

TABLE 13
SUHPC Mixture for Different Curing Regimes (kg/m³)

| | | | | Sand | | |
|---|---|---|---|---|---|---|
| PC | SL | SF | LM 1-PT | 315 μm | W/P | SP |
| 350 | 450 | 100 | 100 | 1124 | 0.18 | 60 |

The chart (FIG. 4) indicated that there was no decline in the compressive strengths in the case of elevated temperature curing regimes, whether tested immediately or after further room temperature curing. There was no obvious difference in the compressive strengths between the curing regimes at the temperatures from 75° C. to 95° C. and the duration of 2 days to 4 days. However, the elevated temperature curing conditions increased the compressive strengths in comparison with the room temperature curing condition.

### SUHPC with Portland Cement Content at 25% by Mass of Powders

The SUHPC (Table 14) with the Portland cement content of 250 kg/m³ showed the compressive strengths of the 3^{th} day and the 28^{th} day as high as 36.4 MPa and 97.1 MPa, respectively.

TABLE 14
Mixture of SUHPC with Portland Cement Content 250 kg/m³

| Constituents (kg/m³) | | | | | | | | | | |
|---|---|---|---|---|---|---|---|---|---|---|
| | | | | | | | | Compressive | | |
| BCM | | | | | Sand | | | Strength | | |
| | | | | LM | 600 | | | (MPa) | | |
| PC | SL | FA | SF | 6-PT | μm | Water | SP | 3 d | 7 d | 28 d |
| 250 | 465 | 50 | 50 | 150 | 1200 | 229 | 32 | 36.4 | 70.1 | 97.1 |

It will be seen upon review of the forgoing embodiments and as otherwise heretofore discussed that the blended cementitious mixtures disclosed herein have high strengths and improved durability over conventional Portland cement concrete. In particular, the present invention is distinct from the prior art in that its properties are obtained by designing the conventional Portland cement concrete constituents to work synergistically at low Portland cement contents.

Although the present invention has been described in considerable details with reference to preferred embodiments, the scope of the claims should not be limited by the preferred embodiments set forth in the examples, but should be given the broadest interpretation consistent with the description as a whole.

### REFERENCES

1. Caijun Shi, Pavel V. Krivenko, Della Roy, 2006, Alkali-Activated Cements and Concretes, Taylor & Francis
2. C. Angulski da Luz, R. D. Hooton, 2015, Influence of curing temperature on the process of hydration of supersulfated cements at early age, Cement and Concrete Research 77, 69-75
3. Dale P. Bentz, Chiara F. Ferraris, Kenneth A. Snyder, 2013, Best Practices Guide for High-Volume Fly Ash Concretes: Assuring Properties and Performance, NIST Technical Note 1812
4. EPFL, 2014, http://actu.epfl.ch/news/a-new-greener-cement-to-meet-future-demand
5. John L. Provis, and Jannie S. J. van Devanter, 2009, Geopolymers: Structure, processing, properties and industrial applications, CRC Press
6. Jussara Tanesi, Dale Bentz, and Ahmad Ardani, 2013, Enhancing High Volume Fly Ash Concretes Using Fine Limestone Powder, ACI SP-294: Advances in Green Binder Systems
7. Katrin Habel, Jean-Philippe Charron, Shadi Braike, R. Douglas Hooton, Paul Gauvreau, Bruno Massicotte, 2008, Ultra-high performance fibre reinforced concrete mix design in central Canada, Canadian Journal of Civil Engineering, 35 (2): 217-224, 10.1139/L07-114
8. Mindess S., Young J. F., Darwin D, 2002, Concrete, 2nd Edition, Prentice Hall, Englewood Cliffs, N.J.
9. Ping Fang, 2013, Development of Sustainable Ultra-High Performance Concrete, MASc. Thesis, University of Toronto
10. U.S. Department of Transportation, 2006, Publication No: FHWA-HRT-06-103, Material Property Characterization of Ultra High-Performance Concrete
11. V. M. Malhotra, P. K. Mehta, 2012a, High-Performance, High-Volume fly ash concrete: for Building Durable and Sustainable Structures, 4th edition

1. A blended cementitious mixture comprising:
a cement included in an amount corresponding to greater than 3% and less than 40% by mass of powders in the cementitious mixture;
supplementary cementitious materials included in an amount corresponding to greater than 50% and less than or equal to 90% by mass of powders in the cementitious mixture; and
a carbonate source included in an amount less than or equal to 20% by mass of powders in the cementitious mixture.

2. The blended cementitious mixture of claim 1, wherein the cement is selected from one of Portland cement and calcium aluminate cement.

3. The blended cementitious mixture of claim 1, wherein the cement is Portland cement comprising one of normal Portland cement (ASTM C150 Type I), high early strength Portland cement (ASTM C150 Type III) and Portland-limestone cement (ASTM C595 Type IL).

4. The blended cementitious mixture of claim 1, wherein the supplementary cementitious materials comprise at least one of ground granulated blast-furnace slag, silica fume, fly ash (F or C class), pozzolans, metakaolin or alternative supplementary cementitious materials.

5. (canceled)

6. The blended cementitious mixture of claim 1, wherein the carbonate source comprises one of limestone powders, dolomite powders, vaterite powders, aragonite powders, cement kiln dusts or a mixture thereof.

7. The blended cementitious mixture of claim 1, wherein the carbonate source has a median particle diameter smaller than or equal to 12 μm.

8. (canceled)

9. The blended cementitious mixture of claim 1, wherein the supplementary cementitious materials comprise a predominant supplementary cementitious material and a subordinate supplementary cementitious material and the predominant supplementary cementitious material and the subordinate supplementary cementitious material combined in a mass ratio in a range of 1:1 to 9:1, respectively.

10. The blended cementitious mixture of claim 9, wherein the predominant supplementary cementitious material is one of ground granulated blast-furnace slag, fly ash (F or C class), pozzolans, or metakaolin, the subordinate supplementary cementitious material is one of ground granulated blast-furnace slag, fly ash (F or C class), pozzolans, metakaolin, silica fume, or a mixture thereof, and the supplementary cementitious material differs from the predominant supplementary cementitious material.

11. The blended cementitious mixture of claim 10, wherein less than or equal to 50% of the predominant supplementary cementitious material by mass of the total supplemental cementitious materials is replaced by limestone powders with a specific surface area greater than 350 m²/kg.

12. The blended cementitious mixture of claim 9, wherein the subordinate supplementary cementitious material has a specific surface area greater than 400 m²/kg.

13. (canceled)

14. A manufacturing process of forming a mortar comprising:
forming the blended cementitious mixture of claim 1;
mixing the blended cementitious mixture of claim 1 with concrete sand, water and chemical admixtures; and
curing the mixture to form the mortar.

15. The manufacturing process of claim 14, wherein the curing is one of: in water or in a humid environment (>90% R.H) at room temperature, steam curing, autoclaved curing, hot water curing or humidity CO₂ environment curing.

16. The mortar formed by the manufacturing process of claim 14.

17. A manufacturing process of forming a concrete comprising:
forming the blended cementitious mixture of claim 1;
mixing the blended cementitious mixture of claim 1 with concrete sand, water, chemical admixtures and coarse aggregates; and
curing the mixture to form the concrete.

18. The manufacturing process of claim 17, wherein the curing is one of: in water, in a humid environment (>90% R.H) at room temperature, steam curing, autoclaved curing, hot water curing or humidity CO₂ environment curing.

19. The concrete formed by the manufacturing process of claim 17.

20. A manufacturing process of forming a sustainable ultra high performance concrete comprising:
forming the blended cementitious mixture of claim 1;
mixing the blended cementitious mixture of claim 1 with sand, water, and chemical admixtures; and
curing the mixture to form the sustainable ultra high performance concrete.

21. The sustainable ultra high performance concrete formed by the manufacturing process of claim 20.

22. The manufacturing process of claim 20 wherein the curing is one of: in water, in a humid environment (>90% R.H) at room temperature, steam curing, autoclaved curing, hot water curing or humidity CO₂ environment curing.

23. The sustainable ultra high performance concrete of claim 21, wherein the sand is one of quartz powders, limestone powders, concrete sand, or a mixture thereof.

24. The concrete of claim 17, wherein the cement is included in an amount equal to or greater than 25% by mass of powders and the concrete has a first day compressive strength of equal to or greater than 10.0 MPa.

25. (canceled)

26. (canceled)

27. The sustainable ultra high performance concrete of claim 21, wherein the cement included in an amount equal to or greater than 25% by mass of powders and the concrete has a first day compressive strength of equal to or greater than 10.0 MPa

28. The sustainable ultra high performance concrete of claim 21, wherein the cement included in an amount equal to or greater than 25% by mass of powders and the concrete has a 28^{th} day compressive strength equal to or greater than 60.0 MPa.

29. The mortar of claim 16, wherein 80% of pores within the mortar are smaller than 10 nm in radius.

30. The concrete of claim 19, wherein 80% of pores within the concrete are smaller than 10 nm in radius.

31. The sustainable ultra high performance concrete of claim 21, wherein 80% of pores within the concrete are smaller than 10 nm in radius.

32. (canceled)

33. (canceled)

34. (canceled)

35. (canceled)

36. (canceled)

37. (canceled)
